(19) United States
(12) Patent Application Publication
(10) Pub. No.: US 2004/0136020 A1
(43) Pub. Date: Jul. 15, 2004

(54) Image processing appartus and method

(75) Inventor: Shuichi Kumada, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/694,837

(22) Filed: Oct. 29, 2003

(30) Foreign Application Priority Data
Oct. 31, 2002 (JP) 2002-318217(PAT.)
Oct. 31, 2002 (JP) 2002-318218(PAT.)
Oct. 27, 2003 (JP) 2003-365479(PAT.)

(51) Int. Cl. H04N 1/60

(52) U.S. Cl. 358/1.9; 358/518; 358/1.13

(57) ABSTRACT

The prevalence of the Internet and the like allows the user to form an image using a printer located at another site. In this case, it is required to simulate (or preview) a color matching output of the printer at a remote site (another site). To this end, a client prompts the user to select a printer used as a print simulation target at the remote site, a printer of the self site, which is used to output the simulation result of the target printer, and a profile required for the color matching process of the print simulation. The selected profile is acquired by searching a profile database present at the remote site or the self site, and a use designation of that profile is sent to the target printer. Image data which is to undergo a color matching process is then transmitted to the target printer, and image data that has undergone the color matching process is received from the target printer. The received image data is transferred to the simulation output printer.

### FIELD OF THE INVENTION

The present invention relates to an image processing apparatus and method and, more particularly, to an image process which allows the user to simulate or preview an output of a printer located at another site via a network such as the Internet or the like.

### BACKGROUND OF THE INVENTION

As described in Japanese Patent Laid-Open No. 7-222009, a color management system (CMS) consists of a Color Management Module (CMM) and device profile, and executes a color mapping process using profiles corresponding to a source device before mapping and a destination device after mapping. The former profile is called a source profile, and the latter profile is called a destination profile.

FIG. 1 shows the color mapping process for mapping a monitor color space (monitor RGB) or color space of print colors (print color CMYK) onto a printer color space (printer CMYK), and FIG. 2 shows the structure of a device profile.

In this case, the source device is a monitor, calibration printer, or standard print colors, and the profile of the monitor or print colors corresponds to a source profile 103. On the other hand, the destination device is a printer, and the profile of that printer corresponds to a destination profile 104.

The profile is divided into a header field 105 for management, and a data storage field 106. The header field 105 stores device information indicating a device (e.g., monitor) to which that profile corresponds, CMM information indicating a CMM which uses that profile, and the like. The data storage field 106 stores profile description information used to identify that profile, and data required for color matching.

The profile description information contains information of a manufacturer name and product name (e.g., “CanonIX-4015”). Also, as the data required for color matching, the monitor profile stores data required to map monitor RGB into CIE XYZ or CIE Lab as a Profile Connection Space (PCS) 102, the print color profile stores data required to map from print color CMYK into the PCS 102, and the printer profile stores data required to map from the PCS 102 to printer CMYK.

The prevalence of the Internet and the like allows the user to print an image using a printer located at another site. In this case, it is required to simulate or preview a color matching output of the printer at a remote site (another site).

### SUMMARY OF THE INVENTION

The present invention has been made to solve the aforementioned problems individually or together, and has as its object to simulate or preview a color matching output of a printer at another site.

In order to achieve the above object, a preferred embodiment of the present invention discloses an image processing apparatus for performing print simulation through a computer network, comprising:

a device selector, arranged to select a color printer on the network as a print simulation target, and to select another color printer on the network which is used to output a simulation result of the target printer;

a profile selector, arranged to select a profile required for a color matching process of the print simulation through the network, and to set the selected profile in the target printer;

a communication section, arranged to transmit image data which is to perform a color matching process to the target printer, and to receive the image data that has performed the color matching process according to the selected profile from the target printer; and

an output section, arranged to make the simulation output printer output an image based on the received image data.

Also, a preferred embodiment of the present invention discloses an image processing apparatus for performing a preview process through a computer network, comprising:

a device selector, arranged to select a color printer on the network as a preview target, and to select a color monitor on the network which is used to display a preview image;

a profile selector, arranged to select a profile required for a color matching process of the preview image through the network, and to set the selected profile in the target printer;

a communication section, arranged to transmit image data which is to perform a color matching process to the target printer, and to receive the image data that has performed the color matching process according to the selected profile from the target printer; and

an output section, arranged to make the preview display monitor display an image based on the received image data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram showing the color mapping process for mapping a monitor color space (monitor RGB) or color space of print colors (print color CMYK) onto a printer color space (printer CMYK);

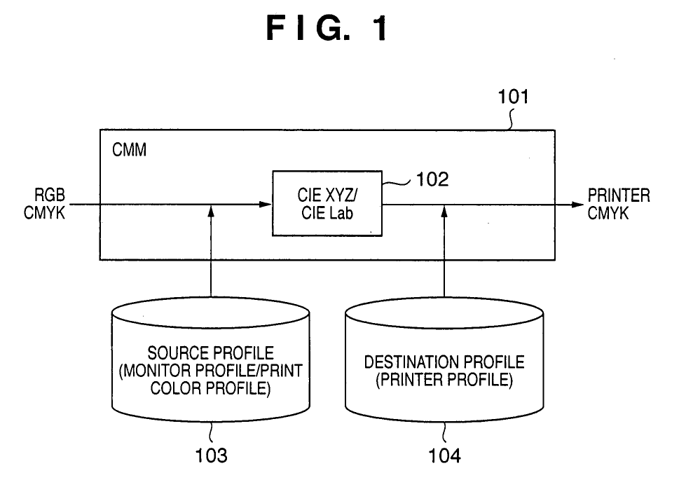

FIG. 2 shows the structure of a device profile;

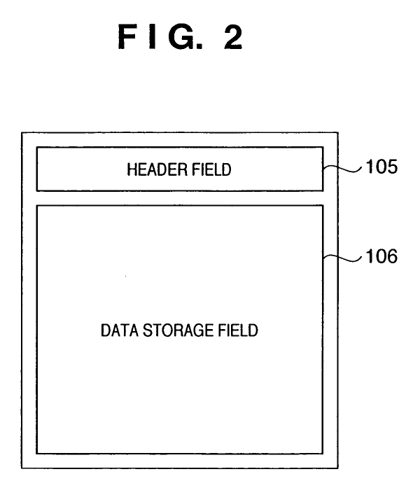

FIG. 3 is a diagram showing the arrangement of a network system according to an embodiment of the present invention;

FIG. 4 shows a user interface;

FIG. 5 is a flow chart showing a simulation output process;

FIG. 6 is a flow chart showing details of a profile setting process;

FIG. 7 is a flow chart showing details of the profile setting process;

FIG. 8 is a flow chart showing details of the simulation output process;

FIG. 9 is a flow chart showing details of a PDL data interpretation process;

FIG. 10 is a diagram showing details of a color matching process;

FIG. 11 is a diagram showing the arrangement of a network system according to the second embodiment;

FIG. 12 is a flow chart showing details of a simulation output process;

FIG. 13 is a flow chart showing details of a PDL data interpretation process;

FIG. 14 is a diagram showing the arrangement of a network system according to the third embodiment;

FIG. 15 is a flow chart showing details of a profile setting process;

FIG. 16 shows a user interface of the fourth embodiment;

FIG. 17 is a flow chart showing a preview process;

FIG. 18 is a flow chart showing details of a profile setting process;

FIG. 19 is a flow chart showing details of the preview process;

FIG. 20 is a diagram showing details of a color matching process;

FIG. 21 is a flow chart showing details of a preview process of the fifth embodiment;

FIG. 22 is a flow chart showing details of a PDL data interpretation process;

FIG. 23 shows a user interface of the sixth embodiment;

FIG. 24 is a flow chart showing a preview process;

FIG. 25 is a flow chart showing details of a profile setting process;

FIG. 26 is a flow chart showing details of the preview process; and

FIG. 27 is a flow chart showing details of an image data interpretation process.

### DETAILED DESCRIPTION OF THE PREFERRED EMBODIMENTS

An image processing apparatus according to preferred embodiments of the present invention will be described in detail hereinafter with reference to the accompanying drawings.

First Embodiment

[Arrangement]

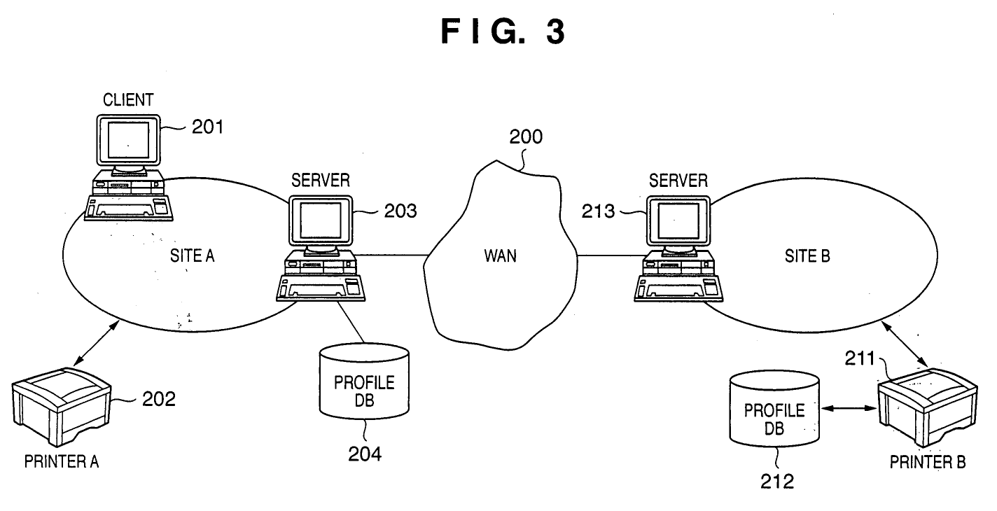

FIG. 3 is a diagram showing the arrangement of a network system according to this embodiment.

A network system of this embodiment is formed by remote sites A and B, which are connected via a wide-area network (WAN) 200 such as the Internet or the like.

Site A includes a client 201, a network printer 202 (which is connected to the network via a printer controller), a server 203 having a connection interface function with the WAN 200, and a profile database (DB) 204 which is connected to the server 203 and stores the profiles of devices and the like. Note that the client 201 comprises a CPU, VRAM, and the like required for monitor display and image processes, and a communication function required for network communications.

On the other hand, site B includes a network printer (which is connected to the network via a printer controller) 211, and a server 213 having a connection interface function with the WAN 200. Note that a profile DB 212 which stores the profiles of devices and the like on site B is connected to the printer controller of the printer 211.

FIG. 3 shows an example wherein one printer is connected to each site. However, a plurality of different types of printers can be connected to each site. Also, the number of sites that form the network system is not limited to two, and may be arbitrarily determined as long as two or mote sites are connected. Furthermore, the sites need not always be connected via the WAN. For example, the present invention may be applied to network systems that connect sites formed for respective buildings, floors, departments, and the like.

[User Interface]

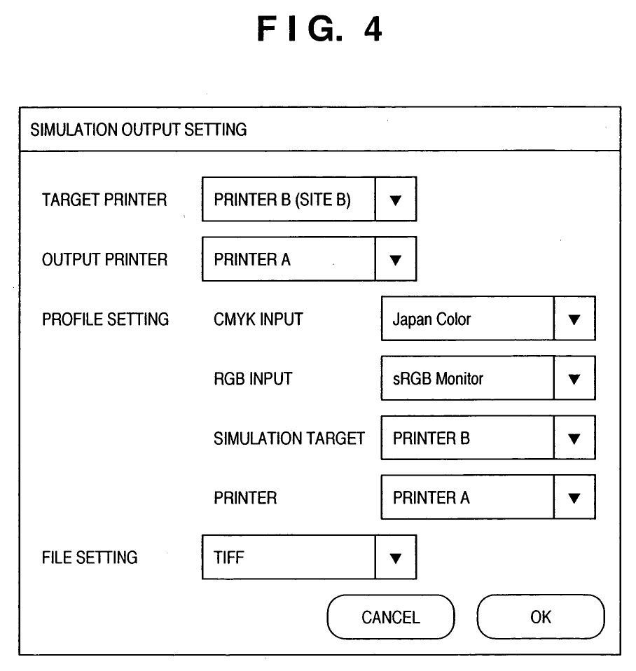

FIG. 4 shows an example of a user interface used to make setups required when the printer 202 simulates and outputs the color matching output of the printer 211 at the client 201. This user interface is displayed on the monitor of the client 201 by software which runs on the client 201.

“Target printer” indicates a printer, the color matching output of which is to be simulated. In the example of FIG. 4, the printer 211 is selected. “Output printer” indicates a printer used to simulate the output. In the example of FIG. 4, the printer 202 is selected.

With “profile setting”, a profile corresponding to the color property of input image data, and profiles of the output printer and target printer can be set or selected. In the example of FIG. 4, a “Japan Color” print profile is selected (set) for a CMYK input image, and an “sRGB Monitor” profile is selected (set) for an RGB input image. A profile of “printer B” as the target printer, and that of “printer A” as the output printer are respectively set as “simulation target” and printer”.

With “file setting”, TIFF, JPEG, JFIF, and the like, which are popularly used as image file formats can be selected. In the example of FIG. 4, TIFF is selected.

Although not shown in FIG. 4, “profile setting” allows setups that consider the resolution, mapping algorithm (e.g., tincture preference, faithful reproduction, vividness preference, etc.), the type of print medium, the type of ink, the regional features preferred by a person who watches an image, and the like. When such information is set, a profile corresponding to the set information is selected.

[Process]

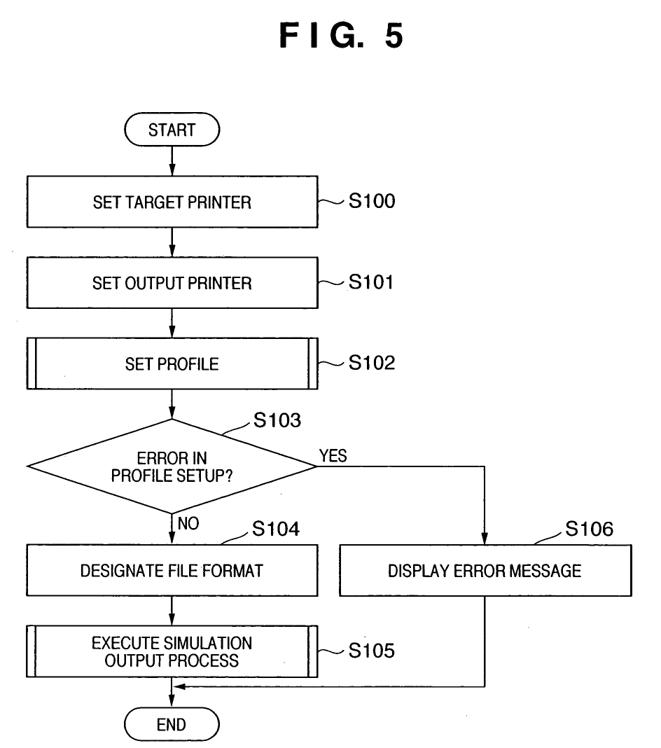

FIG. 5 is a flow chart showing a process for controlling the printer 202 to simulate and output the color matching output result of the printer 211 at site B. This process is implemented by software which runs on the client 201.

When the user has set respective items on the user interface shown in FIG. 4 and has pressed an [OK] button, a target printer and output printer are set in accordance with the setups on the user interface (S100, (S101). Profiles required for the simulation output are set in accordance with the setups on the user interface (S102). It is then checked if an error is found in profile setups (S103). If any error is found, an error message is displayed on the monitor (S106), and the process ends.

If no error is found in profile setups, the printer controller of the target printer is designated with the file format of bitmap image data after color matching in accordance with the setups on the user interface (S104), and a simulation output process is executed (S105).

As a result, when the setups shown in FIG. 4 have been made, the printer 211 at site B executes color matching of an image output from the client 201, and the printer 202 simulates and outputs that color matching result.

*Profile Setting

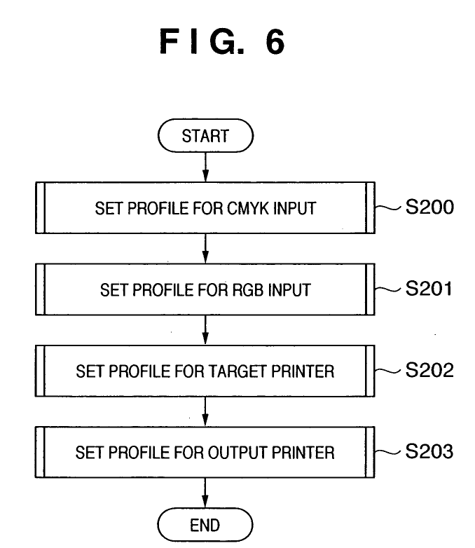

FIG. 6 is a flow chart showing details of the profile setting process (S102).

In accordance with the setups on the user interface, a profile of a color property applied when an input image is CMYK data is set (S200), a profile of a color property applied when an input image is RGB data is set (S201), a profile of the target printer is set (S202), and a profile of the output printer is set (S203).

With a series of such setting processes, the profiles required for the simulation output process are set in the printer controller of the printer 211.

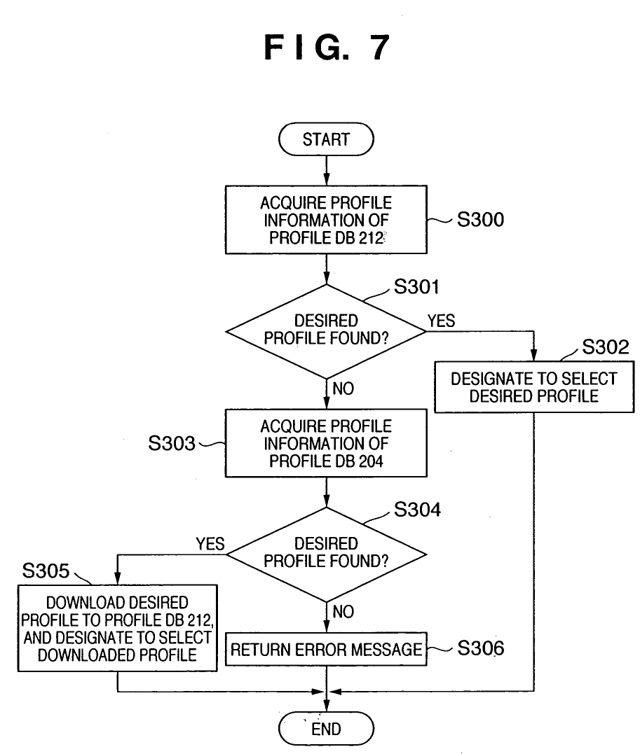

FIG. 7 is a flow chart showing details of the profile setting process in each of steps S200, S201, S202, and S203.

The profile DB 212 of site B is accessed to acquire profile information (list) stored in the profile DB 212 (S300). It is checked if a desired profile is listed in the acquired profile information (S301). If the desired profile is listed, the printer controller of the printer 211 is designated to select that profile (S302), thus ending the process.

If the desired profile is not listed, the profile DB 204 of site A is accessed to acquire profile information (list) stored in the profile DB 204 (S303). It is checked if the desired profile is listed in the acquired profile information (S304). If the desired profile is listed, that profile is downloaded from the profile DB 204 to the profile DB 212, and the printer controller of the printer 211 is designated to select the downloaded profile (S305), thus ending the process.

If the desired profile is not listed in the profile information of the profile DB 204, either, an error message is returned (S306), thus ending the process.

With a series of processes described above, the profile DB on the network is accessed to set required profiles. In this example, the profile search starts from the profile DB 212 connected to the printer 211 of site B. This is for the following reason. That is, when color matching is made using the printer 211 (printer B) as the target printer, the latest profile of “printer B” is more likely to have been downloaded to the profile DB 212. Hence, when such profile is searched for and used, the search time can be shortened, and the latest profile may be used. Of course, the search process of the source profile (S200, S201) may start from either profile DB, and the search process upon setting the profile of the output printer (S203) preferably starts from the profile DB 204.

*Simulation Output Process

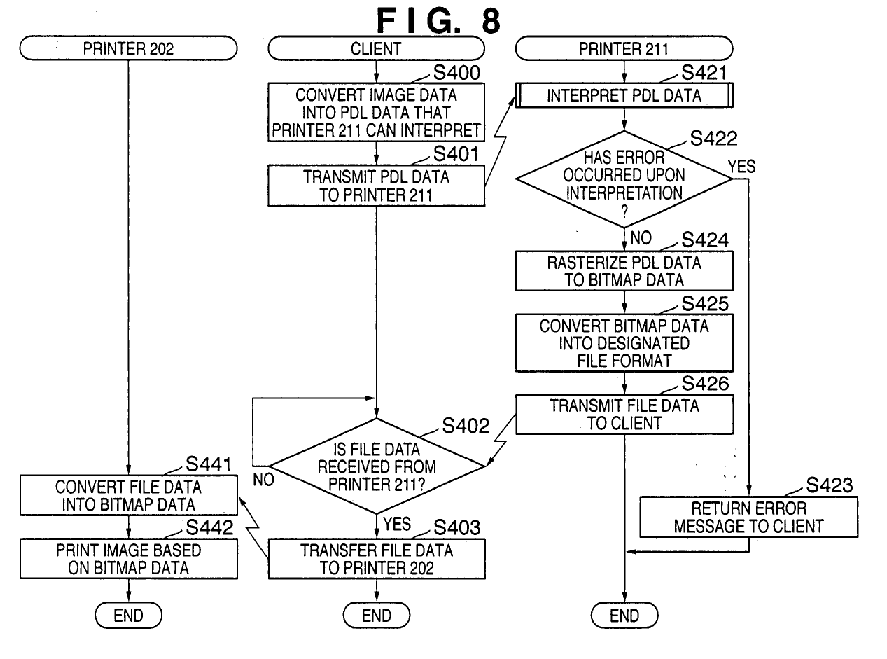

FIG. 8 is a flow chart showing details of the simulation output process in step S105.

A printer driver on the client 201 converts image data into Page Description Language (PDL) data that the printer 211 can interpret (S400), and the PDL data is transmitted to the printer 211 via the servers 203 and 213 (S401).

Upon reception of the PDL data, the printer controller of the printer 211 interprets that PDL data (this process includes a color matching process, as will be described in detail later) (S421), and checks the interpretation result of the PDL data to see if an error has occurred (S422). If an error has occurred, the printer controller returns an error message to the client 201 (S423), thus ending the process. Note that the client 201 that received the error message displays that message on the monitor, and ends the process (not shown in FIG. 8).

If no error is found, the printer controller of the printer 211 rasterizes the PDL data to bitmap data (S424), converts the rasterized bitmap data into the file format designated in step S104 (S425), and transits that file data to the client 201 via the servers 213 and 203 (S426).

Upon reception of the file data from the printer 211 (S402), the client 201 transfers that file data to the printer 202 (S403).

Upon reception of the file data from the client 201, the printer 202 converts that file data into bitmap data (S441), and prints an image based on that bitmap data (S442).

With a series of processes described above, an image output from the client 201 undergoes color matching by the printer 211 of site B, and is simulated and output by the printer 202 of site A.

*Interpretation of PDL data

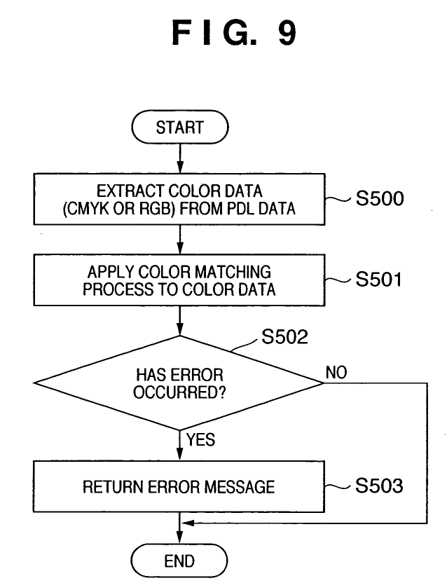

FIG. 9 is a flow chart showing details of the PDL data interpretation process in step S421.

The printer controller of the printer 211 extracts color data (CMYK or RGB) from the PDL data (S500), and applies a color matching process to the extracted color data (S501). The printer controller checks if an error has occurred (S502). If an error has occurred, the printer controller returns an error message (S503), thus ending the process.

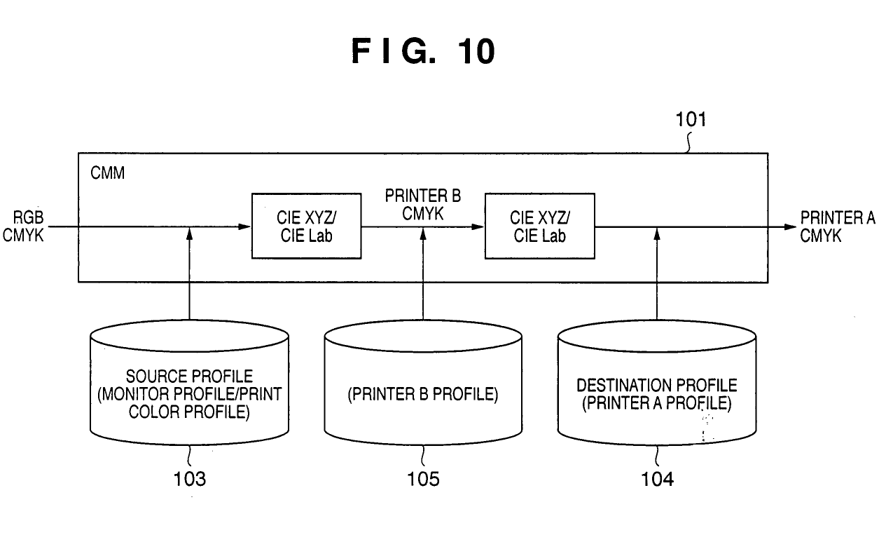

FIG. 10 shows details of the color matching process in step S501.

The printer controller of the printer 211 maps color data into CMYK data according to the color property of “printer B” on the basis of the profiles set in steps S200 to S203, i.e., the monitor profile (sRGB monitor profile in the example of FIG. 4) in case of RGB or the print color profile (Japan Color profile in the example of FIG. 4) in case of CMYK, and the printer profile (that of “printer B” in the example of FIG. 4). Furthermore, the printer controller maps CMYK data of “printer B” to CMYK data according to the color property of “printer A” on the basis of the printer profile (that of “printer B” in the example of FIG. 4) and the printer profile (that of “printer A” in the example of FIG. 4).

That is, the bitmap data rasterized in step S424 is converted to allow the printer 202 to simulate and output the output image of the printer 211. Hence, the user of the client 201 can confirm the tincture of the image to be output by the remote printer 211 by the simulation output of the nearby printer 202.

Second Embodiment

An image processing apparatus according to the second embodiment of the present invention will be described below. Note that the same reference numerals denote the same parts as those in the first embodiment, and a detailed description thereof will be omitted.

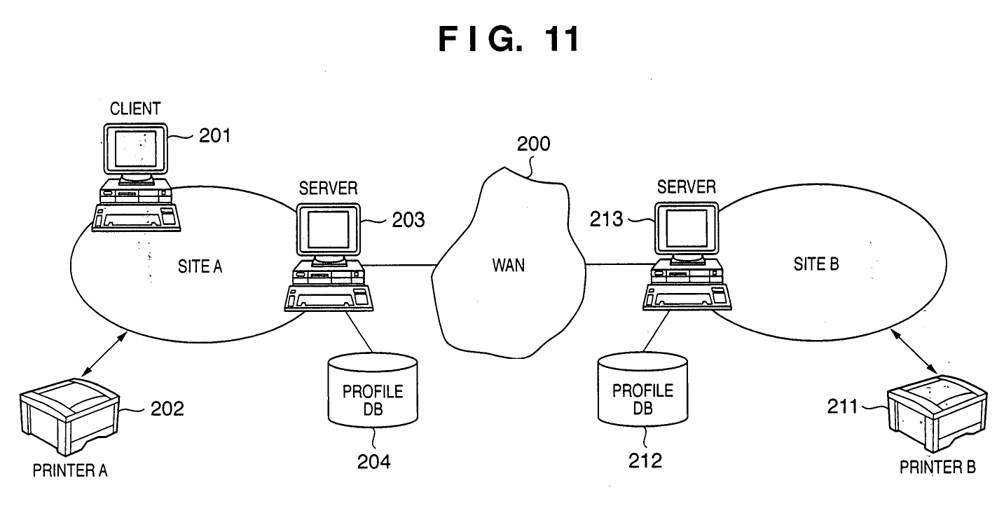

FIG. 11 shows the arrangement of a network system according to the second embodiment. Unlike in the first embodiment, the profile DB 212 is connected to the server 212 in place of the printer controller of the printer 211.

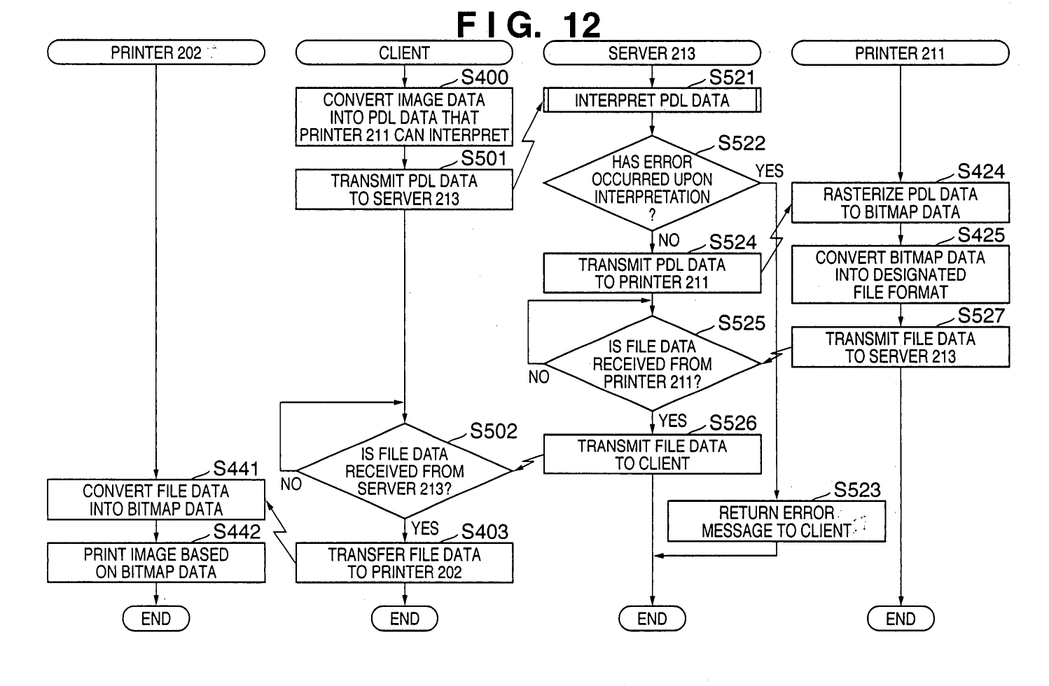

FIG. 12 is a flow chart showing details of the simulation output process in step S105.

The printer driver on the client 201 converts image data into PDL data that the printer 211 can interpret (S400), and the PDL data is transmitted to the server 213 via the server 203 (S501).

Upon reception of the PDL data, the server 213 interprets that PDL data (this process includes a color matching process, as will be described in detail later) (S521), and checks the interpretation result of the PDL data to see if an error has occurred (S522). If an error has occurred, the server 213 returns an error message to the client 201 (S523), thus ending the process. Note that the client 201 that received the error message displays that message on the monitor, and ends the process (not shown in FIG. 12).

If no error is found, the server 213 transmits the PDL data to the printer 211 (S524). Upon reception of the PDL data, the printer controller of the printer 211 rasterizes the PDL data to bitmap data (S424), converts the rasterized bitmap data into the file format designated in step S104 (S425), and transits that file data to the server 213 (S527).

Upon reception of the file data (S525), the server 213 transmits that file data to the client 201 via the server 203 (S426). Upon reception of the file data from the server 213 (S502), the client 201 transfers that file data to the printer 202 (S403).

Upon reception of the file data from the client 201, the printer 202 converts that file data into bitmap data (S441), and prints an image based On that bitmap data (S442).

With a series of processes described above, an image output from the client 201 undergoes color matching by the printer 211 of site B, and is simulated and output by the printer 202 of site A.

In this case, the select and download designations of the profiles shown in FIG. 7 are issued to the server 213 of site B.

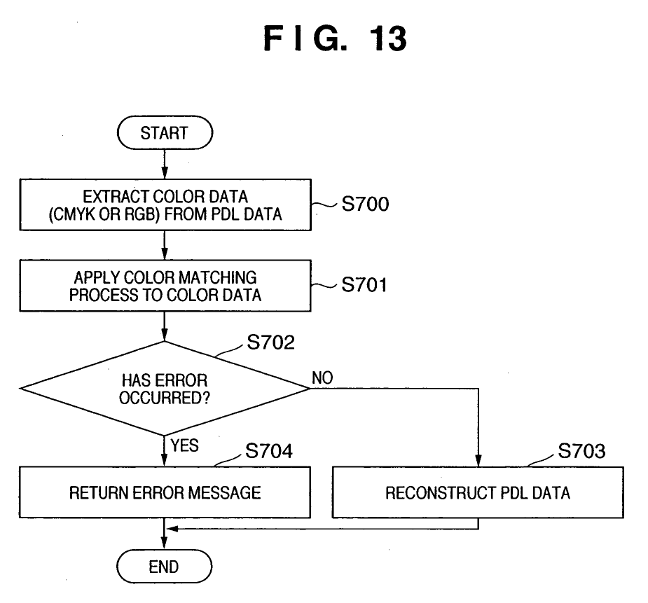

FIG. 13 is a flow chart showing details of the PDL data interpretation process in step S521.

The server 213 extracts color data (CMYK or RGB) from the PDL data (S700), and applies a color matching process to the extracted color data (S701). The server 213 checks if an error has occurred (S702). If an error has occurred, the printer controller returns an error message (S704), thus ending the process. If no error is found, the server 213 reconstructs PDL data, i.e., executes a process for reverting to PDL data in which only the color data has been converted on the basis of the color data converted in step S701 (S703), thus ending the process.

In this manner, the bitmap data rasterized in step S424 is converted to allow the printer 202 to simulate and output the output image of the printer 211. Hence, the user of the client 201 can confirm the tincture of the image to be output by the remote printer 211 by the simulation output of the nearby printer 202.

Third Embodiment

An image processing apparatus according to the third embodiment of the present invention will be described below. Note that the same reference numerals denote the same parts as those in the first embodiment, and a detailed description thereof will be omitted.

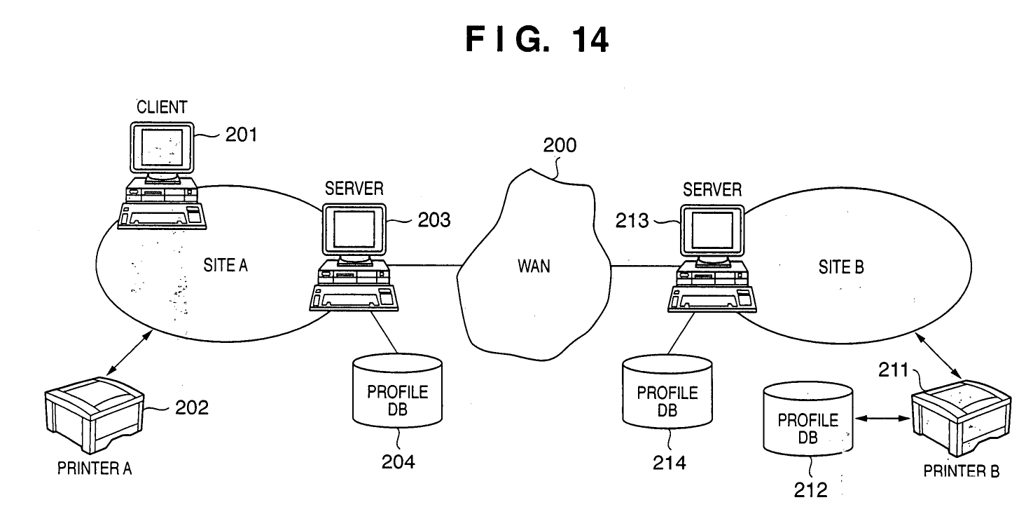

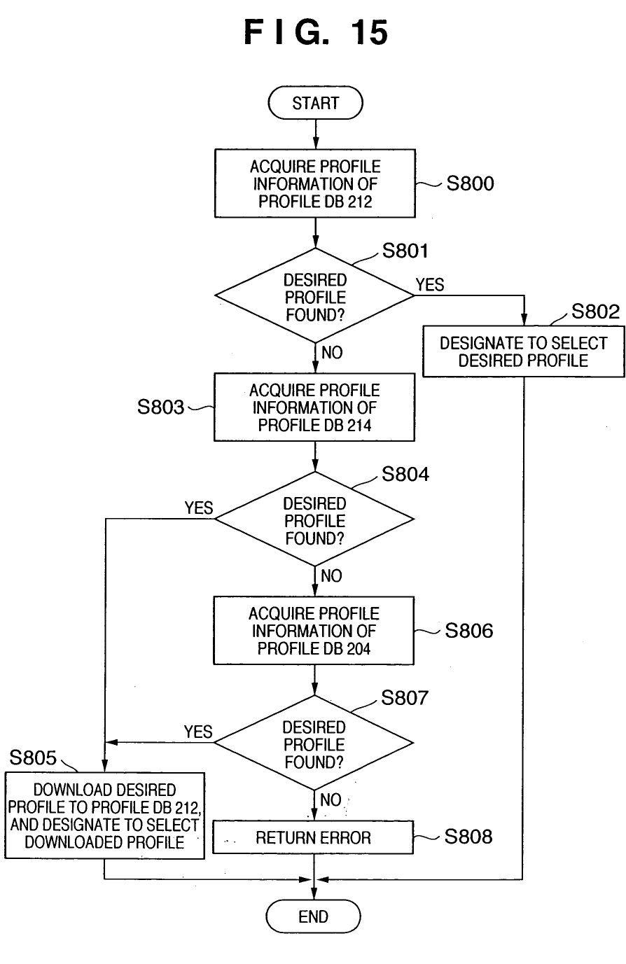

FIG. 14 shows the arrangement of a network system according to the third embodiment. In addition to the arrangement of the first embodiment, a profile DB 214 connected to the server 213 is added. FIG. 15 is a flow chart showing details of the profile setting process in each of steps S200, S201, S202, and S203 shown in FIG. 6.

The profile DB 212 of site B is accessed to acquire profile information (list) stored in the profile DB 212 (S800). It is checked if a desired profile is listed in the acquired profile information (S801). If the desired profile is listed, the printer controller of the printer 211 is designated to select that profile (S802), thus ending the process.

If the desired profile is not listed, the profile DB 214 of site B is accessed to acquire profile information (list) stored in the profile DB 204 (S803). It is checked if the desired profile is listed in the acquired profile information (S804). If the desired profile is listed, that profile is downloaded from the profile DB 214 to the profile DB 212, and the printer controller of the printer 211 is designated to select the downloaded profile (S805), thus ending the process.

If the desired profile is not listed, the profile DB 204 of site A is accessed to acquire profile information (list) stored in the profile DB 204 (S806). It is checked if the desired profile is listed in the acquired profile information (S807). If the desired profile is listed, that profile is downloaded from the profile DB 204 to the profile DB 212, and the printer controller of the printer 211 is designated to select the downloaded profile (S805), thus ending the process.

If the desired profile is not listed in the profile information of the profile DB 204, either, an error message is returned (S808), thus ending the process.

With a series of processes described above, the profile DB on the network is accessed to set required profiles in the printer controller of the printer 211. In this example, the search of the profile of the printer 211 (printer B) starts from the profile DB 212 connected to the printer 211 of site B. If no corresponding profile is found, the profile DB 214 of site B is searched in place of the profile DB 204 of site A. This is because the profile of “printer B” is more likely to be stored in the profile DB 214 than site A. Of course, the search process of the source profile may start from either profile DB, and the search process upon setting the profile of the output printer preferably starts from the profile DB 204, as in the first embodiment.

Regions where sites B and A are present may prefer different colors. For example, site B is located in a high-latitude region, and people who live in the region of site B prefer cold colors. On the other hand, site A is located in a low-latitude region, and people who live in the region of site A prefer warm colors. In this case, when the user who belongs to site A previews the color matching result of the printer 211 using the printer 202 and then prints printouts to be distributed in the region of site B using the printer 211, preferred print results can be obtained using a profile that depends on the features preferred in the region where site B is present. Therefore, in such case, since profiles depending on regional features are more likely to be managed for each site, the profile DBs 212 and 214 of site B are preferably searched in preference to the profile DB 204 of site A.

Fourth Embodiment

An image processing apparatus according to the fourth embodiment of the present invention will be described below. Note that the same reference numerals denote the same parts as those in the first to third embodiments, and a detailed description thereof will be omitted.

The arrangement of a network system according to the fourth embodiment is the same as that of the first embodiment shown in FIG. 3.

[User Interface]

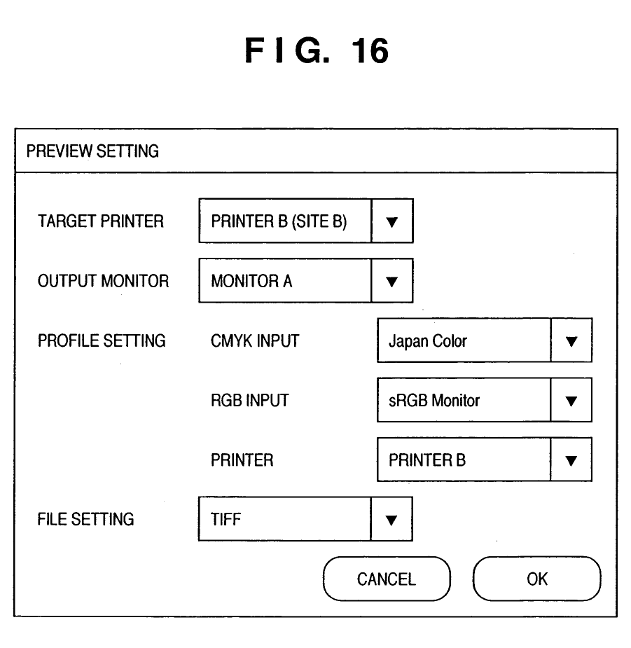

FIG. 16 shows a user interface used to make preview setups upon displaying a preview image of the color matching output of the printer 211 shown in FIG. 3 on the monitor of the client 201 shown in FIG. 3. This user interface is displayed on the monitor of the client 201 by software which runs on the client 201.

“Target printer” indicates a printer, the color matching output of which is to be previewed. In the example of FIG. 16, the printer 211 is selected. “Output monitor” indicates a printer used to preview the output. In the example of FIG. 16, “A monitor” is selected.

With “profile setting”, a profile corresponding to the color property of input image data, and that of the target printer can be set or selected. In the example of FIG. 16, a “Japan Color” print profile is selected (set) for a CMYK input image, and an “sRGB Monitor” profile is selected (set) for an RGB input image. A profile of “printer B” as the target printer is set as a printer profile.

With “file setting”, TIFF, JPEG, JFIF, and the like, which are popularly used as image file formats can be selected. In the example of FIG. 16, TIFF is selected.

Although not shown in FIG. 16, “profile setting” allows setups that consider the resolution, mapping algorithm (e.g., tincture preference, faithful reproduction, vividness preference, etc.), the type of print medium, the type of ink, the regional features preferred by a person who watches an image, and the like. When such information is set, a profile corresponding to the set information is selected.

[Process]

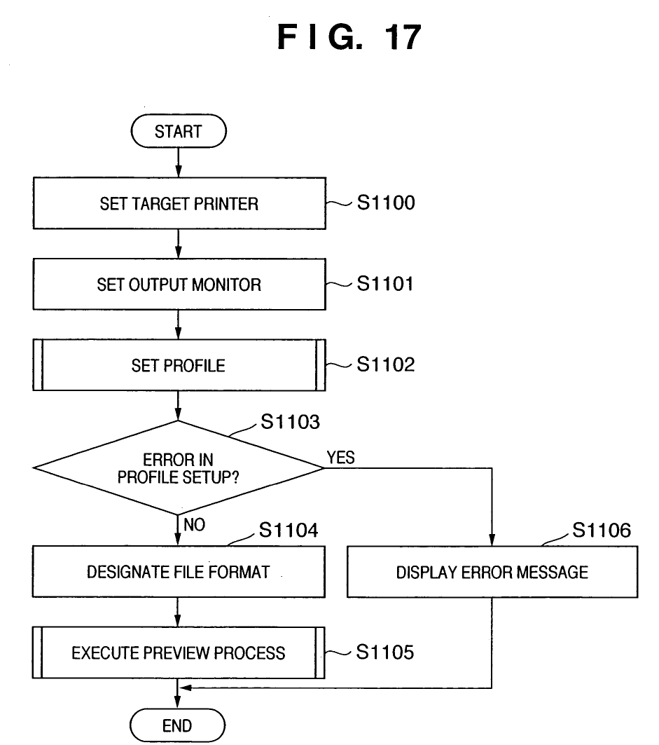

FIG. 17 is a flow chart showing a process for displaying, on the monitor, a preview of the color matching output result of the printer 211 at site B via the network. This process is implemented by software which runs on the client 201.

When the user has set respective items on the user interface shown in FIG. 16 and has pressed an [OK] button, a target printer and output monitor are set in accordance with the setups on the user interface (S1100, S1101). Profiles required to display a preview are set in accordance with the setups on the user interface (S1102). It is then checked if an error is found in profile setups (S1103). If any error is found, an error message is displayed on the monitor (S1106), and the process ends.

If no error is found in profile setups, the printer controller of the target printer is designated with the file format of bitmap image data after color matching in accordance with the setups on the user interface (S1104), and a simulation output process is executed (S1105).

As a result, when the setups shown in FIG. 16 have been made, the printer 211 at site B executes color matching of an image output from the client 201, and the monitor displays a preview of that color matching result.

*Profile Setting

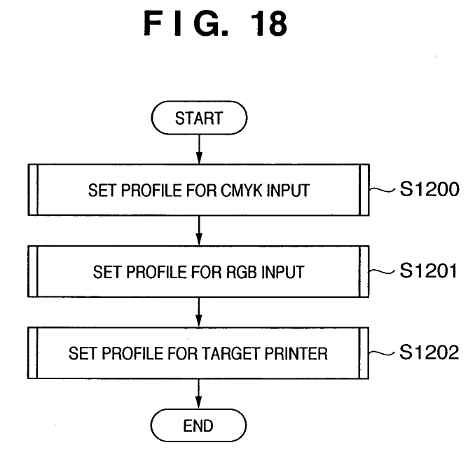

FIG. 18 is a flow chart showing details of the profile setting process (S1102).

In accordance with the setups on the user interface, a profile of a color property applied when an input image is CMYK data is set (S1200), a profile of a color property applied when an input image is RGB data is set (S1201), and a profile of the target printer is set (S1202).

With a series of such setting processes, the profiles required for the preview process are set in the printer controller of the printer 211.

Note that details of the profile setting process in each of steps S1200, S1201, and S1202 are the same as the process shown in the flow chart of FIG. 7.

*Preview Process

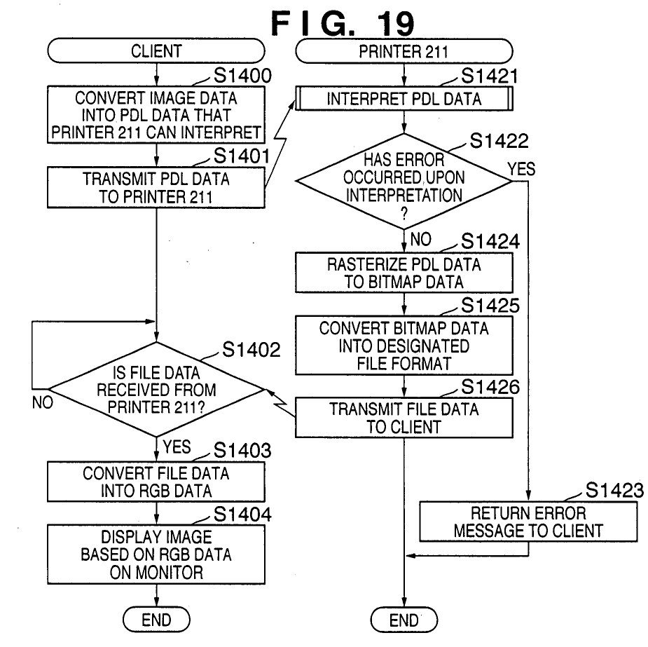

FIG. 19 is a flow chart showing details of the preview process in step S1105.

The printer driver on the client 201 converts image data into Page Description Language (PDL) data that the printer 211 can interpret (S1400), and the PDL data is transmitted to the printer 211 via the servers 203 and 213 (S1401).

Upon reception of the PDL data, the printer controller of the printer 211 interprets that PDL data (this process includes a color matching process, as will be described in detail later) (S1421), and checks the interpretation result of the PDL data to see if an error has occurred (S1422). If an error has occurred, the printer controller returns an error message to the client 201 (S1423), thus ending the process. Note that the client 201 that received the error message displays that message on the monitor, and ends the process (not shown in FIG. 19).

If no error is found, the printer controller of the printer 211 rasterizes the PDL data to bitmap data (S1424), converts the rasterized bitmap data into the file format designated in step S1104 (S1425), and transits that file data to the client 201 via the servers 213 and 203 (S1426).

Upon reception of the file data from the printer 211 (S1402), the client 201 converts that file data into RGB data on the basis of the set printer profile (that of “printer B” in the example of FIG. 16) and monitor profile (that of “A monitor” in the example of FIG. 16) (S1403), and displays an image on the monitor on the basis of that RGB data (S1404). Note that the process in step S1403 includes resolution conversion and the like.

With a series of processes described above, an image output from the client 201 undergoes color matching by the printer 211 of site B, and its preview image is displayed on the monitor of the client 201.

*Interpretation of PDL data

Details of the PDL data interpretation process in step S1421 are the same as the process shown in the flow chart of FIG. 9.

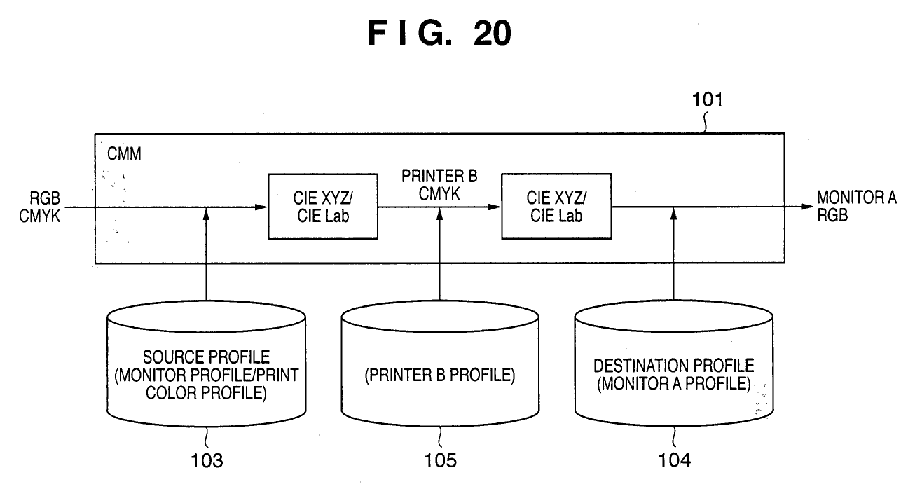

FIG. 20 shows details of the color matching process in step S501 shown in FIG. 9.

The printer controller of the printer 211 maps color data into CMYK data according to the color property of “printer B” on the basis of the profiles set in steps S1200 to S1202, i.e., the monitor profile (sRGB monitor profile in the example of FIG. 16) in case of RGB or the print color profile (Japan Color profile in the example of FIG. 16) in case of CMYK, the printer profile (that of “printer B” in the example of FIG. 16), and the monitor profile (that of A monitor in the example of FIG. 16).

That is, the bitmap data rasterized in step S1424 is converted to simulate the output image of the printer 211. Hence, the user of the client 201 can confirm the tincture of the image to be output by the remote printer 211 by the preview display on the nearby monitor.

Fifth Embodiment

An image processing apparatus according to the fifth embodiment of the present invention will be described below. Note that the same reference numerals denote the same parts as those in the first to fourth embodiments, and a detailed description thereof will be omitted.

The arrangement of a network system according to the fourth embodiment is the same as that of the second embodiment shown in FIG. 11.

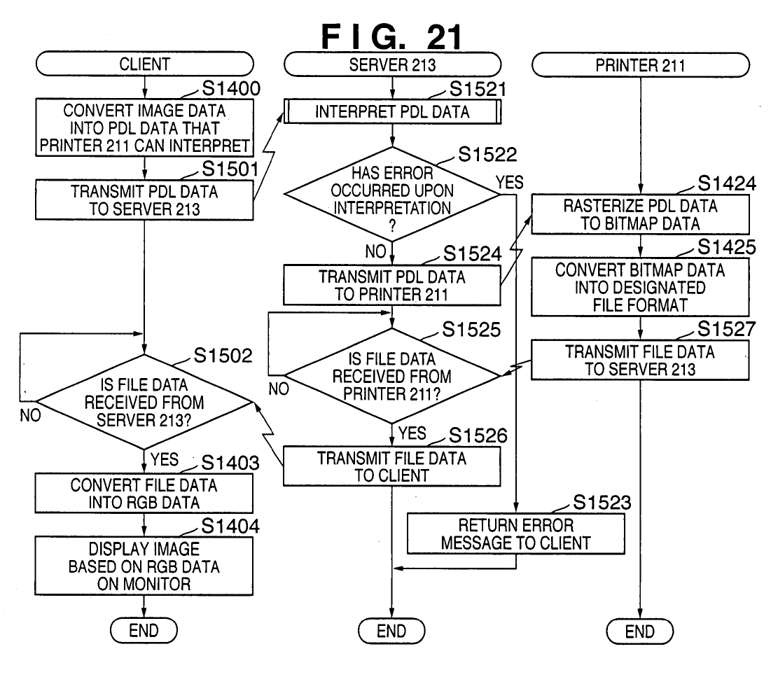

FIG. 21 is a flow chart showing details of the simulation output process in step S1105.

The printer driver on the client 201 shown in FIG. 11 converts image data into PDL data that the printer 211 shown in FIG. 11 can interpret (S1400), and the PDL data is transmitted to the server 213 via the server 203 (S1501).

Upon reception of the PDL data, the server 213 interprets that PDL data (this process includes a color matching process, as will be described in detail later) (S1521), and checks the interpretation result of the PDL data to see if an error has occurred (S1522). If an error has occurred, the server 213 returns an error message to the client 201 (S1523), thus ending the process. Note that the client 201 that received the error message displays that message on the monitor, and ends the process (not shown in FIG. 21).

If no error is found, the server 213 transmits the PDL data to the printer 211 (S1524). Upon reception of the PDL data, the printer controller of the printer 211 rasterizes the PDL data to bitmap data (S1424), converts the rasterized bitmap data into the file format designated in step S1104 (S1425), and transits that file data to the server 213 (S1527).

Upon reception of the file data (S1525), the server 213 transmits that file data to the client 201 via the server 203 (S1426). Upon reception of the file data from the server 213 (S1502), the client 201 converts that file data into RGB data on the basis of the set printer profile (that of “printer B” in the example of FIG. 16) and monitor profile (that of “A monitor” in the example of FIG. 16) (S1403), and displays an image on the monitor on the basis of that RGB data (S1404).

With a series of processes described above, an image output from the client 201 undergoes color matching by the printer 211 of site B, and its preview image is displayed on the monitor of the client 201.

In this case, the select and download designations of the profiles shown in FIG. 7 are issued to the server 213 of site B.

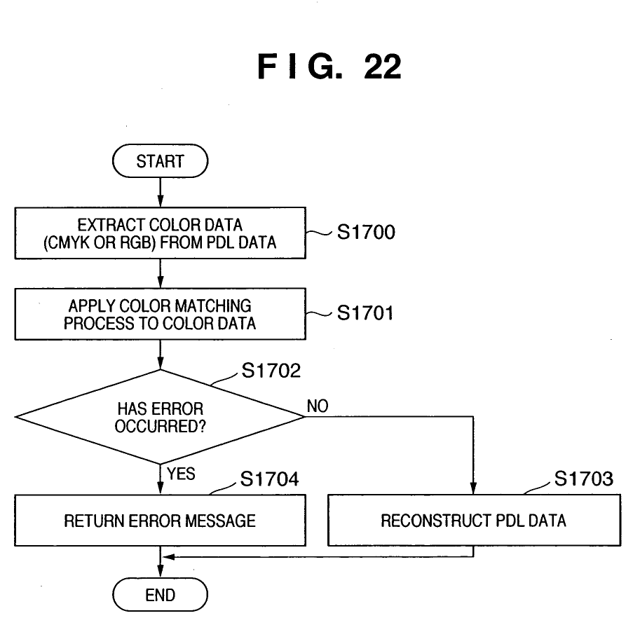

FIG. 22 is a flow chart showing details of the PDL data interpretation process in step S1521.

The server 213 extracts color data (CMYK or RGB) from the PDL data (S1700), and applies a color matching process to the extracted color data (S1701). The server 213 checks if an error has occurred (S1702). If an error has occurred, the printer controller returns an error message (S1704), thus ending the process. If no error is found, the server 213 reconstructs PDL data, i.e., executes a process for reverting to PDL data in which only the color data has been converted on the basis of the color data converted in step S1701 (S1703), thus ending the process.

That is, the bitmap data rasterized in step S1424 is converted to simulate the output image of the printer 211. Hence, the user of the client 201 can confirm the tincture of the image to be output by the remote printer 211 by the preview display on the nearby monitor.

Sixth Embodiment

An image processing apparatus according to the sixth embodiment of the present invention will be described below. Note that the same reference numerals denote the same parts as those in the first to fifth embodiments, and a detailed description thereof will be omitted.

The arrangement of a network system according to the fourth embodiment is the same as that of the first embodiment shown in FIG. 3.

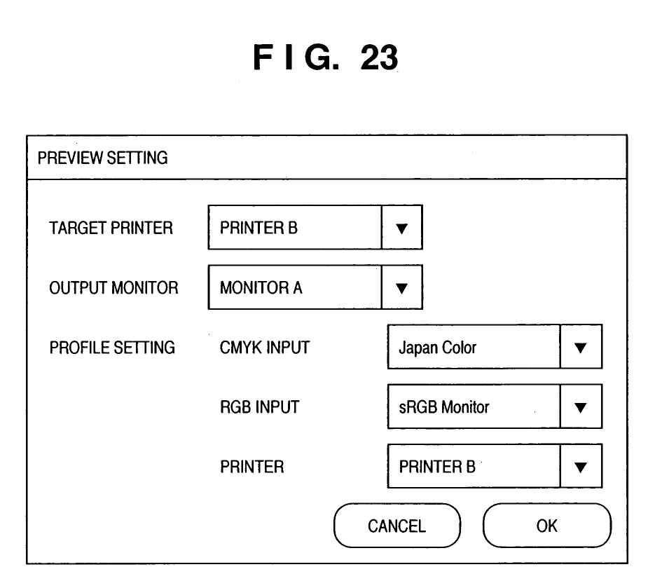

FIG. 23 shows a user interface used to make setups upon displaying a preview image of the color matching output of the printer 211 on, e.g., the monitor of the client 201 shown in FIG. 3. This user interface is displayed on the monitor of the client 201 by software which runs on the client 201. Unlike in the user interface of the fourth embodiment shown in FIG. 16, the user interface of this embodiment does not have any setup item of a file format.

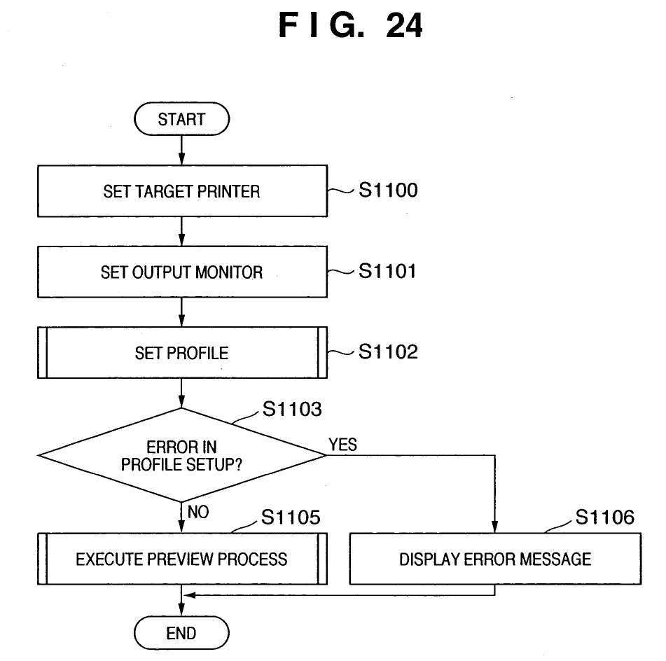

FIG. 24 is a flow chart showing a process for displaying, on the monitor, a preview of the color matching output result of the printer 211 at site B via the network. This process is implemented by software which runs on the client 201. This process is implemented by software which runs on the client 201. Note that this process does not include any file format designation process in step S1104 unlike in the flow chart of the fourth embodiment shown in FIG. 17.

The profiles required for the preview process are set by the same process as in the fourth embodiment shown in FIG. 18.

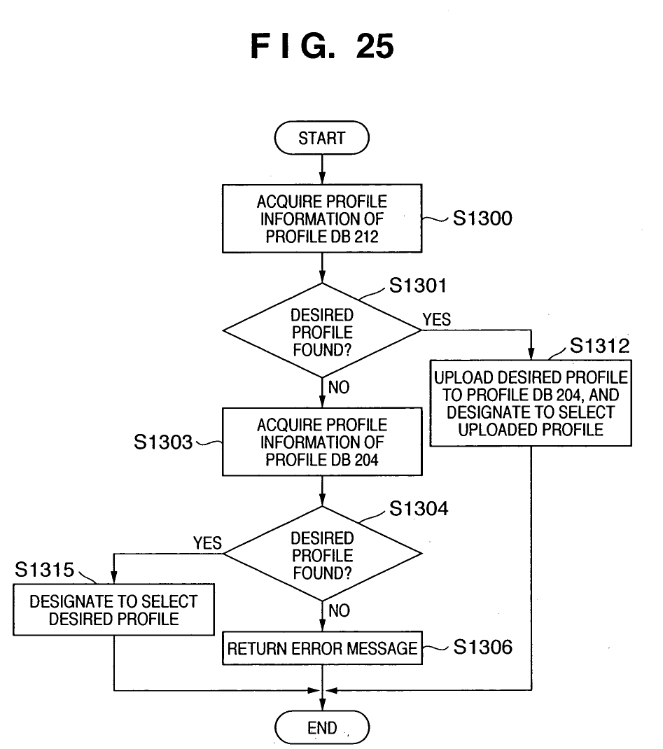

FIG. 25 is a flow chart showing details of the profile setting process in steps S1200, S1201, and S1202.

The profile DB 212 of site B is accessed to acquire profile information (list) stored in the profile DB 212 (S1300). It is checked if a desired profile is listed in the acquired profile information (S1301). If the desired profile is listed, that profile is uploaded from the profile DB 212 to the profile DB 204, and the server 203 is designated to select that uploaded profile (S1312), thus ending the process.

If the desired profile is not listed, the profile DB 204 of site A is accessed to acquire profile information (list) stored in the profile DB 204 (S1303). It is checked if the desired profile is listed in the acquired profile information (S1304). If the desired profile is listed, the server 203 is designated to select that profile (S1315), thus ending the process.

If the desired profile is not listed in the profile information of the profile DB 204, either, an error message is returned (S1306), thus ending the process.

With a series of processes described above, the profile DB on the network is accessed to set required profiles.

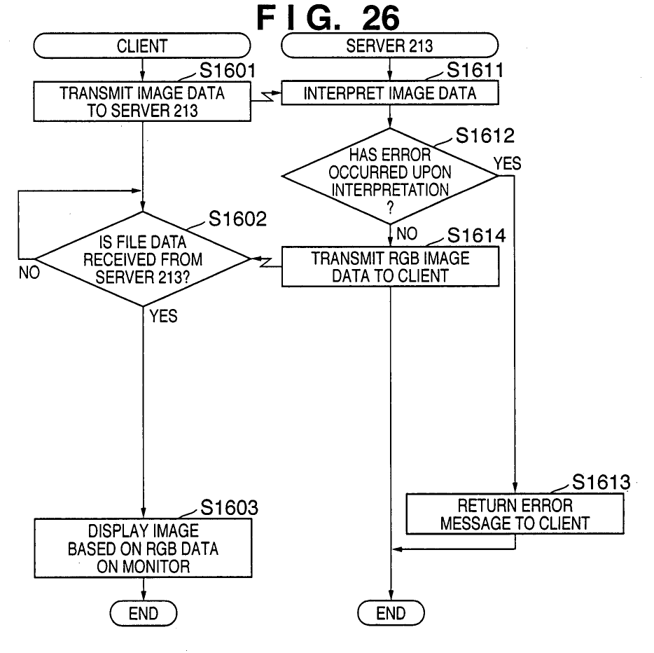

FIG. 26 is a flow chart showing details of the preview process in step S1105.

The client 201 transmits RGB or CMYK image data to the server 203 (S1601).

Upon reception of the image data, the server 203 interprets that image data (S1611), and checks the interpretation result of the image data to see if an error has occurred (S1612). If an error has occurred, the server 213 returns an error message to the client 201 (S1613), thus ending the process. Note that the client 201 that received the error message displays that message on the monitor, and ends the process (not shown in FIG. 26).

If no error is found, the server 213 transmits the image data to the client 201 (S1614). Upon reception of the RGB image data from the server 203 (S1602), the client 201 displays an image on the monitor on the basis of that RGB image data (S1603).

With a series of processes described above, an image output from the client 201 undergoes color matching by the server 203, and its preview image is displayed on the monitor of site A.

In this case, the select and download designations of the profiles shown in FIG. 7 are issued to the server 203 of site A.

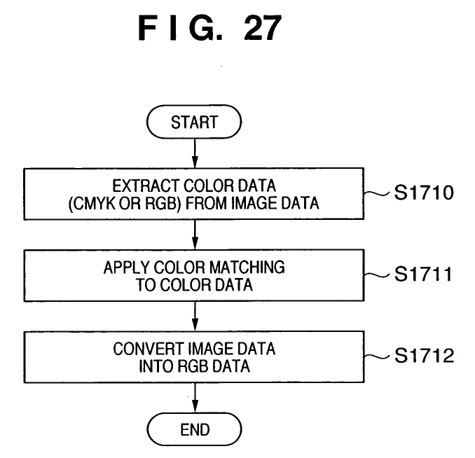

FIG. 27 is a flow chart showing details of the image data interpretation process in step S1611.

The server 203 extracts color data (CMYK or RGB) from the image data (S1710), and applies a color matching process to the extracted color data (S1711). The server 203 converts the image into RGB image data based on the color data converted in step S1711 (S1703), thus ending the process.

In this manner, the RGB image data converted in step S1703 is converted to simulate the output image of the printer 211. Hence, the user of the client 201 can confirm the tincture of the image to be output by the remote printer 211 by the preview display on the nearby monitor.

Note that the same result can be obtained by combining the arrangement of the network system of the fifth embodiment shown in FIG. 11, and the processing sequence described in the sixth embodiment, as can be easily understood by those who are skilled in the art.

Furthermore, when the preview process is executed by preferentially using the profile of the target printer which is present in a site where an image is to be printed out in consideration of the regional features of profiles described in the third embodiment, a preferred print result is more likely to be obtained, as can be easily understood by those who are skilled in the art.

As many apparently widely different embodiments of the present invention can be made without departing from the spirit and scope thereof, it is to be understood that the invention is not limited to the specific embodiments thereof except as defined in the claims.

What is claimed is:

1. An image processing apparatus for performing print simulation through a computer network, comprising:
a device selector, arranged to select a color printer on the network as a print simulation target, and to select another color printer on the network which is used to output a simulation result of the target printer;
a profile selector, arranged to select a profile required for a color matching process of the print simulation through the network, and to set the selected profile in the target printer;
a communication section, arranged to transmit image data which is to perform a color matching process to the target printer, and to receive the image data that has performed the color matching process according to the selected profile from the target printer; and
an output section, arranged to make the simulation output printer output an image based on the received image data.

2. The apparatus according to claim 1, wherein said image processing apparatus and the simulation output printer are present in a single site, the target printer is present in another site, and the two sites are connected through the computer network.

3. The apparatus according to claim 1, wherein the profile is acquired by searching a profile database connected to the target printer, and a profile database present in the same site as said image processing apparatus in turn.

4. The apparatus according to claim 1, wherein the profile is acquired by searching a profile database connected to the target printer, a profile database present in the same site as the target printer, and a profile database present in the same site as said image processing apparatus in turn.

5. The apparatus according to claim 1, further comprising a designator arranged to designate a data format of the image data to be received, which has performed the color matching process, and wherein said communication section informs the target printer of the designated data format.

6. The apparatus according to claim 5, wherein the target printer rasterizes the image data that has performed the color matching process to bitmap data, converts the rasterized bitmap data to image data of the designated data format, and transmits the converted image data to said image processing apparatus.

7. An image processing apparatus for performing print simulation through a computer network, comprising:
a device selector, arranged to select a color printer on the network as a print simulation target, and to select another color printer on the network which is used to output a simulation result of the target printer;
a profile selector, arranged to select a profile required for a color matching process of the print simulation through the network, and to designate a server of a site where the target printer is present to use the selected profile;
a communication section, arranged to transmit image data which is to perform a color matching process to the server, and to receive the image data that has performed the color matching process according to the selected profile from the server; and
an output section, arranged to make the simulation output printer output an image based on the received image data.

8. The apparatus according to claim 7, further comprising a designator arranged to designate a data format of the image data to be received, which has performed the color matching process, and wherein said communication section informs the target printer of the designated data format.

9. The apparatus according to claim 8, wherein the server transmits the image data that has preformed the color matching process to the target printer, and receives image data of the designated data format from the target printer.

10. The apparatus according to claim 9, wherein the target printer rasterizes the image data received from the server into bitmap data, converts the rasterized bitmap data to image data of the designated data format, and transmits the converted image data to server.

11. An image processing apparatus for performing a preview process through a computer network, comprising:
a device selector, arranged to select a color printer on the network as a preview target, and to select a color monitor on the network which is used to display a preview image;
a profile selector, arranged to select a profile required for a color matching process of the preview image through the network, and to set the selected profile in the target printer;
a communication section, arranged to transmit image data which is to perform a color matching process to the target printer, and to receive the image data that has performed the color matching process according to the selected profile from the target printer; and
an output section, arranged to make the preview display monitor display an image based on the received image data.

12. An image processing apparatus for performing a preview process through a computer network, comprising:
a device selector, arranged to select a color printer on the network as a preview target, and to select a color monitor on the network which is used to display a preview image;
a profile selector, arranged to select a profile required for a color matching process of the preview image through the network, and to designate a server of a site where the target printer is present to use the selected profile;
a communication section, arranged to transmit image data which is to perform a color matching process to the server, and to receive the image data that has performed the color matching process according to the selected profile from the server; and
an output section, arranged to make the preview display monitor display an image based on the received image data.

13. An image processing method for performing print simulation through a computer network, comprising steps of:
selecting a color printer on the network as a print simulation target, and selecting another color printer on the network which is used to output a simulation result of the target printer;
selecting a profile required for a color matching process of the print simulation through the network;
setting the selected profile in the target printer;
transmitting image data which is to perform a color matching process to the target printer;
receiving the image data that has performed the color matching process according to the selected profile from the target printer; and
making the simulation output printer output an image based on the received image data.

14. An image processing method for performing print simulation through a computer network, comprising steps of:
selecting a color printer on the network as a print simulation target, and selecting another color printer on the network which is used to output a simulation result of the target printer;
selecting a profile required for a color matching process of the print simulation through the network;
designating a server of a site where the target printer is present to use the selected profile;
transmitting image data which is to perform a color matching process to the server;
receiving the image data that has performed the color matching process according to the selected profile from the server; and
making the simulation output printer output an image based on the received image data.

15. An image processing method for performing a preview process through a computer network, comprising steps of:
selecting a color printer on the network as a preview target, and selecting a color monitor on the network which is used to display a preview image;
selecting a profile required for a color matching process of the preview image through the network;
setting the selected profile in the target printer;
transmitting image data which is to perform a color matching process to the target printer;
receiving the image data that has performed the color matching process according to the selected profile from the target printer; and
making the preview display monitor display an image based on the received image data.

16. An image processing method for performing a preview process through a computer network, comprising steps of:
selecting a color printer on the network as a preview target, and selecting a color monitor on the network which is used to display a preview image;
selecting a profile required for a color matching process of the preview image through the network;
designating a server of a site where the target printer is present to use the selected profile;
transmitting image data which is to perform a color matching process to the server;
receiving the image data that has performed the color matching process according to the selected profile from the server; and
making the preview display monitor display an image based on the received image data.
